(19) United States
(12) Patent Application Publication
(10) Pub. No.: US 2019/0210875 A1
(43) Pub. Date: Jul. 11, 2019

(54) PHOTOCATALYTIC OXIDATION OF HYDROGEN CHLORIDE WITH OXYGEN

(71) Applicant: Covestro Deutschland AG, Leverkusen (DE)

(72) Inventors: Andre RITTERMEIER, Leverkusen (DE); Thomas BURBACH, (US)

(21) Appl. No.: 16/099,336

(22) PCT Filed: May 9, 2017
(86) PCT No.: PCT/EP2017/061053

§ 371 Date: Nov. 6, 2018

(30) Foreign Application Priority Data
May 12, 2016 (EP) 16169332.0

(51) Int. Cl. C01B 7/04; B01J 23/46; B01J 37/34; B01J 35/00

(52) U.S. Cl. CPC C01B 7/04; B01J 35/004; B01J 37/345; B01J 23/462

(57) ABSTRACT

The invention relates to a method for the production of chlorine by means of photocatalytic oxidation of gaseous hydrogen chloride with oxygen as an oxidizing agent, in which the reaction is started on the surface of a photocatalyst by the action of UV radiation in a selective energy range.

The invention relates to a method for producing chlorine by photocatalytic oxidation of gaseous hydrogen chloride with oxygen as oxidizing agent. The comparatively low temperatures in the novel method to that of the prior art allow the achievement of very high degrees of HCl conversion owing to the position of the thermodynamic equilibrium and thus a more efficient work-up of the reaction products.

In the production of many organic compounds and the production of raw materials for the production of polymers, chlorine (Cl₂) is used as reaction partner in the production chain. When converting chlorine-containing intermediates to chlorine-free end products, hydrogen chloride (HCl) is frequently formed as by-product. An example of this reaction chain is the production of polyurethanes via phosgene as intermediate. The hydrogen chloride obtained can be further used, for example by marketing the aqueous solution (hydrochloric acid) or by using the hydrogen chloride in the syntheses of other chemical products. The amounts of hydrogen chloride obtained, however, cannot always be fully used at the site of its production. Transport of hydrogen chloride or hydrochloric acid over long distances is uneconomical. The disposal of hydrogen chloride by neutralization with aqueous sodium hydroxide solution is technically possible, but is also unattractive from an economic and ecological point of view. For economic and ecological reasons, therefore, production using a closed chlorine circuit is desirable. This should include the recycling of hydrogen chloride to chlorine. Due to the essential role of chlorine chemistry in the chemical industry and due to the large amounts of hydrogen chloride obtained, in the order of magnitude of ≥10⁹ kg/a in Germany alone, technologies for HCl recycling have an enormous economic significance.

HCl recycling processes are known from the prior art (cf. Ullmann Enzyklopädie der technischen Chemie (Ullmann's Encyclopedia of Industrial Chemistry), Weinheim, 4th Edition 1975, Vol. 9, pp. 357 ff. or Winnacker-Küchler: Chemische Technik, Prozesse und Produkte (Chemical Technology, Processes and Products), Wiley-VCH Verlag, 5th Edition 2005, Vol. 3, pp. 512 ff.): these particularly include the electrolysis of hydrochloric acid and the oxidation of hydrogen chloride. The process of catalytic hydrogen chloride oxidation with oxygen in an exothermic equilibrium reaction developed by Deacon in 1868 was at the genesis of industrial chlorine chemistry:

4HCl+O₂→2Cl₂+2H₂O

Chloralkali electrolysis, however, eclipsed the Deacon process to a substantial degree. Virtually all chlorine was produced by electrolysis of aqueous sodium chloride solutions [Ullmann Encyclopedia of industrial chemistry, seventh release, 2006]. However, the attractiveness of the Deacon process has been increasing recently again, since global chlorine demand is growing faster than the demand for sodium hydroxide solution. This development favors the process for producing chlorine by oxidation of hydrogen chloride decoupled from the production of sodium hydroxide solution. In addition, hydrogen chloride is obtained as a coproduct in large amounts in phosgenation reactions for example, for instance in isocyanate production.

The Deacon reaction can either be carried out purely thermally at high temperatures (>700° C.) or in the presence of catalysts at a temperature of 300 to 450° C. The purely thermal Deacon reaction is not used for HCl recycling on an industrial scale.

The first catalysts for HCl gas phase oxidation contained copper in the oxidic form as an active component and had already been described by Deacon as early as 1868. These catalysts deactivated rapidly because the active component was volatilized at the high process temperatures.

HCl gas phase oxidation by means of chromium oxide-based catalysts is also known. However, under oxidizing conditions chromium-based catalysts have a tendency to form chromium(VI) oxides which are very toxic and have to be prevented from entering the environment, thus entailing technical complexity.

Furthermore, a short service life is implied in other publications (WO 2009/035234 A, page 4, line 10).

Ruthenium-based catalysts for HCl gas phase oxidation were described for the first time in 1965, but the activity of these RuCl₃/SiO₂ catalysts was quite low (see: DE 1567788 A1). Further catalysts comprising the active components ruthenium dioxide, mixed oxides of ruthenium or ruthenium chloride in combination with various support oxides, such as titanium dioxide or tin dioxide have also been described previously (see for example: EP 743277A1, U.S. Pat. No. 5,908,607, EP 2026905 A1 and EP 2027062 A2).

The Deacon reaction proceeds exothermically (standard reaction enthalpy −57 kJ/mol chlorine) and reversibly. At the reaction temperature of ≥300° C. required for the industrial process, the reaction equilibrium no longer lies fully on the product side. From the known thermodynamic data for the reaction it follows that, for example at 350° C. reaction temperature, 0.1 MPa gas pressure and stoichiometric reactant ratios (HCl: 02=4:1 mol/mol), a maximum degree of HCl conversion of around 85% is achievable. A higher degree of HCl conversion is only achievable by an excess of oxygen, but at the price of higher complexity for the work-up of the reaction products. If the reaction temperature could be lowered to 150° C., an equilibrium conversion of up to 99% would be possible.

In order to be able to lower the reaction temperatures to the thermodynamically favorable range (<300° C.), so-called non-thermal excitation sources were investigated. Such method principles are described, for example, in Stiller (W. Stiller: Nichtthermisch aktivierte Chemie [Non-thermally activated chemistry]. Birkheuser Verlag, Basel, Boston, 1987, pp. 33-34, pp. 45-49, pp. 122-124, pp. 138-145). HCl oxidation methods using non-thermal activation are described in the documents JP 5 907 3405, RU A 2253 607, DD 88 309, SUA 180 1943, Cooper et al. (W. W. Cooper, H. S. Mickley, R. F. Baddour: Oxidation of hydrogen chloride in a microwave discharge. Ind. Eng. Chern. Fundam. 7(3), 400-409 (1968).), van Drumpt (J. D. van Drumpt: Oxidation of Hydrogen Chloride with Molecular Oxygen in a Silent Electrical Discharge. Ind. Eng. Chern. Fundam. 22(4), 594-595 (1972)) and DE 10 2006 022 761 A1. They are based predominantly on the photochemical activation of one of the two reaction partners, HCl or O₂. JP 59-73 405A describes the photooxidation of gaseous hydrogen chloride, in which pulsed laser radiation is used for excitation of the reactants or a high pressure mercury vapor lamp or even a combination of both photon sources cited.

RU 2 253 607 likewise describes a photochemical method for chlorine production in which an HCl-air mixture flows through a tubular reactor and the reactants are activated in a reaction zone by means of a mercury vapor radiation source.

EP1914199 describes a method for chlorine production from a mixture comprising gaseous hydrogen chloride and oxygen under exposure to ultraviolet radiation at a wavelength in the range of 165 nm to 270 nm at an ultraviolet radiation density of (10-40)*10⁻⁴ W/cm³ and a pressure of not more than 0.1 MPa. The oxidation of hydrogen chloride is effected by the activated oxygen with formation of the target product. An almost quantitative degree of conversion is claimed without any heating of the product mixture. It is not mentioned how much energy expenditure is required for the excitation sources (UV or electrons) to achieve the degree of conversion specified. Furthermore, no details of the residence time of the reactants or the size of the reaction apparatuses used are given. According to the application, the main reaction path is via excited (individual) oxygen atoms, ozone only being mentioned as by-product of the oxygen excitation.

DD 88 309 A describes a catalyzed HCl oxidation at 150°-250° C., which is additionally supported by the use of UV radiation that is not defined in detail.

The document DE 10200 602 276 A1 describes an integrated method for producing isocyanates from phosgene and at least one amine and oxidation of the hydrogen chloride obtained herein with oxygen to give chlorine, wherein the chlorine is recycled to the production of phosgene. The document is based in particular on methods for producing chlorine by non-thermal activated reaction of hydrogen chloride with oxygen, in which unreacted hydrogen chloride and oxygen and possibly further minor constituents such as carbon dioxide and nitrogen chlorine are removed from the gas mixture formed in the reaction, consisting of at least the target products chlorine and water, and is recycled to phosgene production.

The main disadvantage of the non-thermal HCl oxidation processes described to date is their unsatisfactory energy efficiency. In no case has a sufficiently high degree of HCl conversion (>90%) been described, such as is sought with the present invention.

The document WO 2010 020 345 A1 describes a method for heterogeneously catalyzed oxidation of hydrogen chloride by means of gases comprising oxygen, characterized in that a gas mixture consisting of at least hydrogen chloride and oxygen flows through a suitable solid catalyst and at the same time is exposed to the effect of a non-thermal plasma.

However, even in this case a sufficiently high degree of HCl conversion of 90% is only achieved at a temperature of 350° C. At 150° C., the degree of HCl conversion even fell to 63%.

The object of the present invention is therefore to provide a method for recycling hydrogen chloride to chlorine which can be operated in a simple, safe and energy efficient manner. In particular, a very high degree of hydrogen chloride conversion should be achieved (particularly at least 90%), even in the case of declining activity of an oxidation catalyst, in order thus to simplify the work-up of the reaction products and to maintain a high plant capacity over long operating periods.

The object presented above is achieved according to the invention by a heterogeneously photocatalyzed oxidation of hydrogen chloride with oxygen, particularly at relatively low catalyst temperature.

The invention relates to a method for heterogeneously photocatalyzed oxidation of hydrogen chloride by means of UV radiation, characterized in that a gas mixture composed of at least hydrogen chloride, oxygen and optionally further minor constituents is produced and is passed over a solid photocatalyst and the reaction is started on the surface of the catalyst by exposure to UV radiation in a selective energy range.

In a preferred embodiment of the novel method, the UV radiation, which is used for the photocatalyzed oxidation, encompasses an energy range from 3.2 to 4 eV, preferably from 3.26 to 3.94 eV.

In a particularly preferred embodiment of the novel method, the UV radiation is generated by UV LED lamps.

The photocatalyst preferably has at least one photoactive material such as a transition metal or transition metal oxide or a semiconductor material. In the context of the invention, photoactive refers to a material that, on irradiation with UV radiation, generates the reaction energy for the conversion of molecular oxygen (O₂) to an active oxygen species on the surface of the catalyst.

In a preferred method, a photocatalyst is used which comprises, as additional catalytic active component (also referred to here as co-catalyst), metals which are also active in the thermocatalytic HCl oxidation, such as metals of transition groups 1, 7 or 8 of the Periodic Table of the Elements or oxides, oxychtorides or chlorides of the metals of transition groups 1, 3, 6, 7 or 8, or mixtures of these metals or metal compounds. As co-catalyst, preference is given to using at least one compound from the series: CuCl₂, FeCl₃, Cr₂O₃, chromium oxychloride, RuO₂, ruthenium oxychloride, RuCl₂, CeO₂ and cerium oxychloride.

As co-catalyst for the photocatalyzed oxidation, very particular preference is given to using one or more catalysts selected from the series: ruthenium oxide, ruthenium chloride and ruthenium oxychloride.

The photocatalyst particularly preferably comprises at least one photoactive material consisting of one or more compounds selected from the series: AlCuO₂, AlₓGa_{y}In_{1-x-y}N, AlₓIn₁₋ₓN, AlN, B₆O, BaTiO₃, CdS, CeO₂, Fe₂O₃, GaN, Hg₂SO₄, InₓGa₁₋ₓN, In₂O₃, KTaO₃, LiMgN, NaTaO, Nb₂O, NiO, PbHfO₃, PbTiO₃, PbZrO₃, Sb₄Cl₂O₅, Sb₂O₃, SiC, SnO₂, SrCu₂O₂, SrTiO₃, TiO₂, WO₃, ZnO, ZnS, ZnSe, which can be activated by irradiation with UV light.

The reaction temperature of the photocatalytic HCl oxidation with UV radiation is set according to a preferred method in a range to a maximum of 250° C., preferably from 20 to 250° C., particularly preferably from 20 to 150° C.

In a particularly preferred method, the HCl oxidation is carried out advantageously at elevated pressure, particularly at a pressure of up to 25 bar, preferably up to 10 bar. This facilitates, for example, the coupling of other prior HCl oxidation stages which are purely catalyzed oxidation reactions of hydrogen chloride with gases comprising oxygen.

A possible embodiment is an extension of the novel method, characterized in that the photocatalytic HCl oxidation is combined with one or more other types of HCl oxidation reactions selected from the series: catalytic gas phase oxidation, thermal gas phase oxidation and electrolysis of HCl gas, and is conducted downstream as a further stage to the one or more other HCl oxidation reactions.

The other HCl oxidation reaction is preferably a thermocatalyzed oxidation reaction of hydrogen chloride with gases comprising oxygen (Deacon reaction).

A possible preferred embodiment consists of a combination of a catalyzed Deacon reaction, which is operated at elevated temperature, particularly at at least 300° C., with a downstream photocatalytic oxidation at a lower temperature, in particular <300° C.

Whereas the thermocatalytic HCl oxidation with molecular oxygen (O₂) over customary Deacon catalysts (CuCl₂, FeCl₃, Cr₂O₃, RuO₂, CeO₂, etc.) requires a reaction temperature of typically 300° C. and more, it has been found that, surprisingly, over some catalysts by means of photocatalytic HCl oxidation, a rapid and smooth oxidation of hydrogen chloride to chlorine is possible even at a much lower temperature, particularly preferably at 20 to 150° C.

It has been found that numerous heterogeneous catalysts, particularly comprising metals or metal compounds of transition groups 1, 3, 6, 7 and 8 of the Periodic Table of the Elements, support this reaction. A particularly preferred catalyst for the photocatalytic HCl oxidation, for example, consists of ruthenium oxide on titanium dioxide. This catalyst may be identical to the Deacon catalyst that is also effective at high temperatures, which is particularly used for the possible upstream other thermocatalytic HCl oxidation.

Various metals and metal compounds can be excited by UV light in order to catalyze reactions photochemically. As an example, the photocatalytic oxidation of CO on titanium dioxide-supported catalysts may be listed (doi:10.1016/S0926-3373(03)00162-0). In this case, the photoactive material is excited by light of a defined wavelength. In this excited state, the material can convert molecular oxygen (O₂) to an active oxygen species, which can then react with another substance, this therefore being oxidized.

In the photocatalyzed HCl oxidation according to the invention, it has been found that, surprisingly, a customary Deacon catalyst (e.g. CuCl₂, FeCl₃, Cr₂O₃, RuO₂, CeO₂, etc. as described above) on a photoactive material, such as a transition metal oxide or a semiconductor (AlCuO₂, AlₓGa_{y}In_{1-x-y}N, AlₓIn₁₋ₓN, AlN, B₆O, BaTiO₃, CdS, CeO₂, Fe₂O₃, GaN, Hg₂SO₄, InₓGa₁₋ₓN, In₂O₃, KTaO₃, LiMgN, NaTaO₃, Nb₂O₅, NiO, PbHfO₃, PbTiO₃, PbZrO₃, Sb₄Cl₂O₅, Sb₂O₃, SiC, SnO₂, SrCu₂O₂, SrTiO₃, TiO₂, WO₃, ZnO, ZnS, ZnSe) can be activated by irradiation with UV light such that the photocatalyzed HCl oxidation is already possible at very low temperature and at high degrees of conversion.

By means of the novel photocatalyzed HCl oxidation at low reaction temperatures, the thermodynamic equilibrium of the HCl oxidation reaction can be shifted far to the side of the reaction products chlorine and water. The small amounts of hydrogen chloride remaining in the product stream at a high degree of HCl conversion requires no cumbersome recovery. They can be removed by a simple water wash. This also simplifies the product work-up and thus improves the economic viability of the method.

The novel photocatalyzed HCl oxidation already described above is particularly preferably used in combination with the thermocatalyzed gas phase reaction with molecular oxygen, also known as the Deacon process. In this process, hydrogen chloride is oxidized with oxygen in an exothermic equilibrium reaction over a catalyst to afford chlorine while generating steam as by-product. The reaction temperature is typically 250 to 500° C. and the standard reaction pressure is 1 to 25 bar. Since the reaction is an equilibrium reaction, it is appropriate to work at minimum temperatures at which the catalyst still has a sufficient activity. It is also appropriate to use oxygen in superstoichiometric amounts relative to hydrogen chloride. A two- to four-fold oxygen excess, for example, is typical. Since there is no risk of any selectivity losses, it can be economically advantageous to operate at relatively high pressure, and accordingly with a longer residence time than at standard pressure.

Suitable preferred catalysts for the Deacon process include ruthenium oxide, ruthenium chloride or other ruthenium compounds on silicon dioxide, aluminum oxide, titanium dioxide, tin dioxide or zirconium dioxide as support and cerium oxide, cerium chloride or other cerium compounds on silicon dioxide, aluminum oxide, titanium dioxide, tin dioxide, zirconium dioxide as support. Suitable catalysts may be obtained, for example, by applying ruthenium chloride to the support and subsequent drying or drying and calcination. Suitable catalysts may contain, in addition to or instead of a ruthenium compound, also compounds of other noble metals, for example gold, palladium, platinum, osmium, iridium, silver, copper or rhenium. Suitable catalysts may also contain chromium(III) oxide.

The thermally catalyzed hydrogen chloride oxidation may be conducted adiabatically or preferably isothermally or virtually isothermally, batchwise but preferably continuously, as a fluidized bed or fixed bed process, preferably as a fixed bed process, particularly preferably in tube bundle reactors over heterogeneous catalysts at a reactor temperature of 180 to 500° C., preferably 200 to 400° C., more preferably 220 to 350° C., and a pressure of 1 to 25 bar (1000 to 25 000 hPa), preferably 1.2 to 20 bar, more preferably 1.5 to 17 bar and especially 2.0 to 15 bar.

Typical reaction apparatuses in which the catalyzed hydrogen chloride oxidation is performed are fixed bed or fluidized bed reactors. The catalyzed hydrogen chloride oxidation can preferably also be performed in a plurality of stages.

In the isothermal or virtually isothermal procedure, also two or more, i.e. 2 to 10, preferably 2 to 6, particularly preferably 2 to 5, especially 2 to 3 reactors connected in series may be used with additional intermediate cooling. The hydrogen chloride may be added either in its entirety upstream of the first reactor together with the oxygen or such that it is distributed over the various reactors. This serial connection of individual reactors can also be combined in one apparatus.

A further preferred embodiment of an apparatus suitable for the method consists in using a structured catalyst bed in which the catalyst activity increases in the direction of flow. Such a structuring of the catalyst bed can be accomplished through varying impregnation of the catalyst supports with active mass or through varying dilution of the catalyst with an inert material. Employable inert materials are for example rings, cylinders or spheres of titanium dioxide, zirconium dioxide or mixtures thereof, aluminum oxide, steatite, ceramic, glass, graphite or stainless steel. In the case of the preferred use of shaped catalyst bodies, the inert material should preferably have similar external dimensions.

Suitable shaped catalyst bodies include shaped bodies with any desired forms, preference being given to tablets, rings, cylinders, stars, wagonwheels or spheres, particular preference being given to rings, cylinders or star extrudates, as the form.

Suitable heterogeneous catalysts are particularly ruthenium compounds or copper compounds on support materials, which may also be doped, preference being given to optionally doped ruthenium catalysts. Suitable support materials are, for example, silicon dioxide, graphite, titanium dioxide with rutile or anatase structure, tin dioxide, zirconium dioxide, aluminum oxide or mixtures thereof, preferably titanium dioxide, zirconium oxide, aluminum oxide or mixtures thereof, more preferably γ- or δ-aluminum oxide or mixtures thereof.

The supported copper or ruthenium catalysts may be obtained, for example, by impregnating the support material with aqueous solutions of CuCl₂ or RuCl₃ and optionally a promoter for doping, preferably in the form of its chloride. The forming of the catalyst can be carried out after or preferably before impregnating the support material.

For doping of the catalysts, suitable promoters are alkali metals such as lithium, sodium, potassium, rubidium and cesium, preferably lithium, sodium and potassium, more preferably potassium, alkaline earth metals such as magnesium, calcium, strontium and barium, preferably magnesium and calcium, more preferably magnesium, rare earth metals such as scandium, yttrium, lanthanum, cerium, praseodymium and neodymium, preferably scandium, yttrium, lanthanum and cerium, more preferably lanthanum and cerium, or mixtures thereof.

The shaped bodies may then be dried at a temperature of 100 to 400° C., preferably 100 to 300° C., for example under an atmosphere of nitrogen, argon or air, and may be optionally calcined. The shaped bodies are preferably initially dried at 100 to 150° C. and subsequently calcined at 200 to 400° C.

The conversion of hydrogen chloride in a single pass may preferably be limited to 15% to 90%, preferably 40% to 85%, particularly preferably 50% to 70%.

In a particularly preferred variant of the novel method, firstly the major portion of the HCl oxidation is conducted in the other catalyzed oxidation process, in particular up to an HCl conversion of at least 70%, preferably to an extent of at least 80%, which is upstream of the photocatalyzed HCl oxidation with UV radiation.

The volume ratio of hydrogen chloride to oxygen at the reactor inlet is preferably from 1:1 to 20:1, preferably 1:1 to 8:1, more preferably 1:1 to 5:1.

The chlorine produced by the novel method is further used in production processes for producing polymers such as polyurethanes and PVC, which supply the hydrogen chloride as by-product for the novel oxidation method.

The invention is more particularly elucidated hereinbelow by the examples, which do not, however, constitute any limitation of the invention.

### EXAMPLES

### Example 1 (Inventive)

A catalyst consisting of ruthenium oxide supported on titanium dioxide was charged in a fixed bed in an annular gap quartz photoreactor (annular gap diameter 7 mm) and a gas mixture of 0.25 L/h (standard conditions STP) hydrogen chloride, 1 L/h (STP) oxygen and 10 L/h nitrogen (STP) were passed therethrough at room temperature. The quartz photoreactor was irradiated externally with a 5 m UV LED light band (12 W/meter) with UV light of the wavelength 365 nm. After 1 h, the product gas stream was passed into a 30% by weight potassium iodide solution for 15 min. The iodine formed was then back-titrated with 0.1N thiosulfate standard solution to determine the amount of chlorine introduced. A hydrogen chloride conversion of 90.1% was measured.

### Example 2 (Comparative Example)

A catalyst consisting of ruthenium oxide supported on titanium dioxide was charged in a fixed bed in an annular gap quartz photoreactor (annular gap diameter 7 mm) and a gas mixture of 1 L/h (standard conditions STP) hydrogen chloride, 4 L/h (STP) oxygen and 5 L/h nitrogen (STP) were passed therethrough at room temperature. No UV light was irradiated into the reactor. After 2 h, the product gas stream was passed into a 30% by weight potassium iodide solution for 30 min. The iodine formed was then back-titrated with 0.1 N thiosulfate standard solution to determine the amount of chlorine introduced. A hydrogen chloride conversion of 0.0% was measured.

### Example 2 (Comparative Example)

Titanium dioxide (DMS2005-0260) was charged in a fixed bed in an annular gap quartz photoreactor (annular gap diameter 7 mm) and a gas mixture of 1 L/h (standard conditions STP) hydrogen chloride, 4 L/h (STP) oxygen and 5 L/h nitrogen (STP) were passed therethrough at room temperature. The quartz photoreactor was irradiated externally with a 5 m UV LED light band (12 W/meter) with UV light of the wavelength 365 nm. After 2 h, the product gas stream was passed into a 30% by weight potassium iodide solution for 30 min. The iodine formed was then back-titrated with 0.1 N thiosulfate standard solution to determine the amount of chlorine introduced. A hydrogen chloride conversion of 0.2% was measured.

1.-12. (canceled)

13. A method for heterogeneously photocatalyzed oxidation of hydrogen chloride by means of UV radiation, wherein a gas mixture composed of at least hydrogen chloride, oxygen and optionally further minor constituents is produced and is passed over a solid photocatalyst and the reaction is started on the surface of the catalyst by exposure to UV radiation in a selective energy range.

14. The method as claimed in claim 13, wherein the photocatalyst comprises at least one photoactive material such as a transition metal or transition metal oxide or a semiconductor material.

15. The method as claimed in claim 14, wherein the photocatalyst comprises, as additional catalytic active component (co-catalyst), metals of transition groups 1, 7 or 8 of the Periodic Table of the Elements or oxides, oxychlorides or chlorides of the metals of transition groups 1, 3, 6, 7 or 8, or mixtures of these metals or metal compounds.

16. The method as claimed in claim 14, wherein the photocatalyst as photoactive material comprises one or more compounds selected from the series: AlCuO₂, AlₓGa_{y}In_{1-x-y}N, AlₓIn₁₋ₓN, AlN, B₆O, BaTiO₃, CdS, CeO₂, Fe₂O₃, GaN, Hg₂SO₄, InₓGa₁₋ₓN, In₂O₃, KTaO₃, LiMgN, NaTaO₃, Nb₂O₅, NiO, PbHfO₃, PbTiO₃, PbZrO₃, Sb₄Cl₂O₅, Sb₂O₃, SiC, SnO₂, SrCu₂O₂, SrTiO₃, TiO₂, WO₃, ZnO, ZnS, ZnSe.

17. The method as claimed in claim 13, wherein the photocatalytic HCl oxidation with UV radiation is conducted at elevated pressure, particularly at a pressure of up to 25 bar.

18. The method as claimed in claim 13, wherein the reaction temperature of the photocatalytic HCl oxidation with UV radiation is at most 250° C.

19. The method as claimed in claim 13, wherein the photocatalytic HCl oxidation is combined with one or more other types of HCl oxidation reactions selected from the series: catalytic gas phase oxidation, thermal gas phase oxidation and electrolysis of HCl gas, and is conducted downstream as a further stage to the one or more other HCl oxidation reactions.

20. The method as claimed in claim 19, wherein the other HCl oxidation reaction applied is the catalyzed oxidation reaction of hydrogen chloride with gases comprising oxygen.

21. The method as claimed in claim 19, wherein firstly the major portion of the HCl oxidation is conducted in the other catalyzed oxidation process, in particular up to an HCl conversion of at least 70%, which is upstream of the photocatalyzed HCl oxidation with UV radiation.

22. The method as claimed in claim 13, wherein the UV radiation for the photocatalyzed oxidation encompasses an energy range from 3.2 to 4 eV.

23. The method as claimed in claim 13, wherein the co-catalyst used for the photocatalyzed oxidation is one or more catalysts selected from the series: ruthenium oxide, ruthenium chloride and ruthenium oxychloride.

24. The method as claimed in claim 13, wherein a UV LED lamp is used as UV light source of the UV radiation.
